(19) United States
(12) Patent Application Publication
(10) Pub. No.: US 2011/0060436 A1
(43) Pub. Date: Mar. 10, 2011

(54) BINAURAL AUDIO AND PROCESSING OF AUDIO SIGNALS

(75) Inventor: Vittorio Gandini, Milano (IT)

(73) Assignee: AKANEMO S.R.L., Busto Garolfo (IT)

(21) Appl. No.: 12/991,798

(22) PCT Filed: May 15, 2008
(86) PCT No.: PCT/IT08/00321

§ 371 Date: Nov. 9, 2010

(51) Int. Cl. G06F 17/00

(52) U.S. Cl. 700/94

(57) ABSTRACT

A stereo biauricular audio recording, in which the notes stored in a first channel of the recording are stored in the same sequence in a second channel of the recording but are frequency-shifted by a same value, and a method for processing an audio signal, comprising the steps of: acquiring a set of data adapted to define an audio signal; selecting a frequency shift; generating a first digital audio recording by synthesizing it according to the data set; generating a second digital audio recording by synthesizing it according to the data set and to the frequency shift; selecting a channel of the first audio recording, selecting a channel of the second audio recording, mixing the two channels in a third audio recording which comprises at least two channels.

### TECHNICAL FIELD

The present invention relates to the field of digital audio signal processing and in particular to the field of the generation of sound effects which cannot be perceived consciously by the human ear and are applied in particular to an action induced on the brainwaves of the listener in order to obtain beneficial effects for the listener.

### BACKGROUND ART

Encoding and listening to music in a digital format has been an increasingly common practice for many years. Nowadays, all personal computers are equipped with a sound card, speakers or audio headphone sockets, which allow to play back sounds encoded in suitable formats. Portable recreational devices, such as portable video game systems or music players, have also enjoyed considerable success.

Digital audio formats have become dominant for their practicality in recording, manipulating and distributing sound.

The distribution of music by means of audio files instead of by means of physical objects, for example, has allowed to distribute music over the Internet, an opportunity which has reduced distribution costs significantly and has allowed an ever larger number of people to access the enjoyment of music.

However, it must be noted that the digital format in itself provides no added value to the music listening experience: such formats in fact only allow to play back, with higher or lower accuracy, the same type of sound that can be played by an analog system: the main advantage is constituted by the possibility to store, process and transmit pieces of music and sound in general by means of electronic media which are compact and easy to use.

Indeed in order to improve the audio experience, advanced sound playback techniques have been devised and implemented through the years in order to expand and enrich the sound enjoyment experience both in the pure musical field and in motion picture sound or for video games.

For example, multichannel digital audio recording techniques have been particularly important. In multichannel audio, the audio stream is divided into a plurality of separate tracks, each of which can be sent, during listening, to a different speaker. These techniques are aimed at giving greater spatiality to sound and therefore higher realism, since sound in nature originates almost always from a number of points in space. Thanks to these techniques, the audio is no longer perceived flatly and with no dynamic range, but on the contrary the listener has the feeling of a surrounding audio environment which moves continuously around him.

A typical example of the application of these techniques is constituted by systems of the so-called “surround” type, which consist in applying multichannel audio to channels which “surround” the listener, giving the feeling that the sound originates from a number of spatial points and thus providing a more immersive and realistic effect. The sound thus perceived is therefore very full and immersive, and is often capable of generating more intense emotions in the listener than conventional single-channel or stereo sound.

Another direction that has been followed in order to attempt to enrich the experience of the listener relates to the attempt to influence directly the mental state of the listener by using the stimulation of specific brainwaves, which work and respond at frequencies that the human ear is unable to pick up.

Brainwave frequency varies depending on the type of activity in which the brain is involved. Scientists commonly divide the waves into four bands, which correspond to four frequency bands and reflect different activities of the brain.

Delta waves are comprised in the range from 0.5 Hz to 4 Hz, correspond to deep sleep and are associated with the deepest mental and physical relaxation.

Theta waves are comprised in the range from 4 Hz to 8 Hz, correspond to drowsiness and to the first stage of sleep and are typical of the mind engaged in imagination, visualization, creative inspiration activities.

Alpha waves are comprised in the range from 8 Hz to 14 Hz, correspond to alert relaxation and are associated with a state of alert but relaxed consciousness.

Beta waves are comprised in the range from 14 Hz to 30 Hz, correspond to a state of alertness and concentration and are associated with ordinary waking activities, when one is concentrated on external stimuli.

On the basis of the phenomenon of resonance, if the brain is subjected to pulses at a given frequency, its natural tendency is to tune to them. For example, if the subject is in the wakeful state and therefore his brain activity is comprised in the beta wave band, and he is subjected for a certain period to a 10-Hz (alpha wave) stimulation, his brain tends to modify its activity in the direction of the received stimulus, thus passing to a state of relaxation which is typical of alpha waves.

Thanks to this phenomenon it is possible to generate sound effects which stimulate brain waves, adopting the theory of biauricular rhythm. According to the teachings of this theory, sound effects which cannot be detected by the human ear but generate a frequency which can be detected by the brain are introduced in any piece of music, so as to induce desirable effects, such as relaxation, anxiety reduction, increased concentration, increased creativity.

In particular, the biauricular rhythm theory states that if the left ear is stimulated with a carrier sound at a frequency f and simultaneously the right ear is stimulated with a carrier sound at a frequency equal to f+Δf, the difference Δf between the frequencies is not perceived by hearing but only at the subconscious level by the brain, which tends to resonate with such frequency.

For example, if Δf is selected equal to 10 Hz (alpha waves), the brain will tend to resonate with the frequency of 10 Hz and accordingly with the corresponding activity related to relaxation, calmness and tranquillity. In this manner, concentration is enhanced and meditation is facilitated in the listener.

The introduction of electronics and computer technology applied to the music sector has allowed to use these frequencies, conveying them by means of sound waves in order to try to condition the state of mind of a listener. Pieces of music are already commercially available in which backing tracks or accompaniments are inserted which encapsulate this effect. Listening to these pieces of music, especially by means of ordinary stereo headphones, allows to stimulate brain waves in order to provide a feeling of relaxation or excitement.

These effects are typically provided by inserting within a recording some backing tracks, particularly percussions, which are recorded in stereo or two-channel format and in which the frequency of the note recorded on the second channel is shifted by the desired value.

However, it has been observed that the stimulus induced by these recordings according to the background art is not sufficiently high, since the perception of the biauricular accompaniments is often excessively conditioned by the rest of the music or sound played back at that time.

### DISCLOSURE OF THE INVENTION

The aim of the present invention is to overcome the limitations of the background art noted above, by proposing a new method and system for generating biauricular audio which increases biauricular perception and the corresponding beneficial effects during listening.

Within this aim, an object of the present invention is to devise a method and a system which allow the listener to perceive the biauricular effects more substantially.

Another object of the present invention is to allow a dynamic generation of biauricular audio, allowing a user to generate a biauricular piece of music starting from any piece of music of his choice, selecting the preferred type of waves (alpha, beta, delta or theta).

Another object of the present invention is to allow the enjoyment of biauricular effects during the execution of activities normally performed by the listener, for example while playing a video game.

This aim and these and other objects which will become better apparent hereinafter are achieved by a multichannel, preferably two-channel, audio recording, comprising an audio track composed of a sequence of musical notes, characterized in that each note in said sequence is encoded in a first channel at a frequency f and each note in said sequence is encoded in a second channel at a frequency f+Δf.

The intended aim and objects are further achieved by a method for processing an audio signal, which comprises the steps of: acquiring a set of data adapted to define an audio signal; selecting a frequency shift; generating a first digital audio recording by synthesizing it according to the data set; generating a second digital audio recording by synthesizing it according to the data set and to the frequency shift; selecting a channel of the first audio recording, selecting a channel of the second audio recording, mixing the two channels in a third audio recording which comprises at least two channels.

This aim and these and other objects are also achieved by a system for processing an audio signal, which comprises: means for acquiring a set of data adapted to define an audio signal; means for selecting a frequency shift; a first synthesizer, adapted to generate a first digital audio recording on the basis of the data adapted to define an audio signal; a second synthesizer, adapted to generate a second digital audio recording on the basis of the data suitable to define an audio signal and of the frequency shift; a mixer adapted to select a channel of the first audio recording, select a channel of the second audio recording, mix the two channels in a third audio recording which comprises at least two channels.

Conveniently, the first audio recording or the second audio recording can be a single-channel audio recording or a multichannel, preferably two-channel, audio recording.

Preferably, the second audio recording is obtained by applying a frequency shift to each note of the data sequence adapted to define the audio signal and synthesizing the resulting file.

The data adapted to define the audio signal can be represented in any format adapted to define the characteristics of a note, which can include the musical instrument, the frequency and the timbre of each note. In particular, the audio definition data can be in the MIDI (“Musical Instrument. Digital Interface”) format.

In a preferred embodiment, the frequency shift of each note between the first channel and the second channel is comprised in a range from 0.5 Hz to 30 Hz, more preferably from 2 Hz to 20 Hz.

The first, second and third audio recordings produced by the processing of the definition data can be in any proprietary or standardized format, for example in wave (“way”), mp3 (“mp3”), extended audio (“xac”), Apple (“aiff”), “Apple-C” (“aifc”), Amiga (“iff”), Sun (“au”), Sound Blaster (“voc”), raw (“snd”), MIDI instrument sample (“sds”), Sample Vision (“smp”), Dialogic (“vox”), Matlab (“mat”), Numerical Text (“txt”), FLAC (“flac”), Ogg (“ogg”), Windows Media Audio (“wma”) or in any other format made available in the course of time.

### BRIEF DESCRIPTION OF DRAWINGS

Further characteristics and advantages of the present invention will become better apparent from the following detailed description, given by way of non-limiting example and accompanied by the corresponding figures, wherein:

FIG. 1 is a block diagram of the system according to the present invention;

FIG. 2 is a more detailed block diagram of the system based on the present invention;

FIG. 3 is a flowchart of the operation of the system according to the present invention.

### WAYS OF CARRYING OUT THE INVENTION

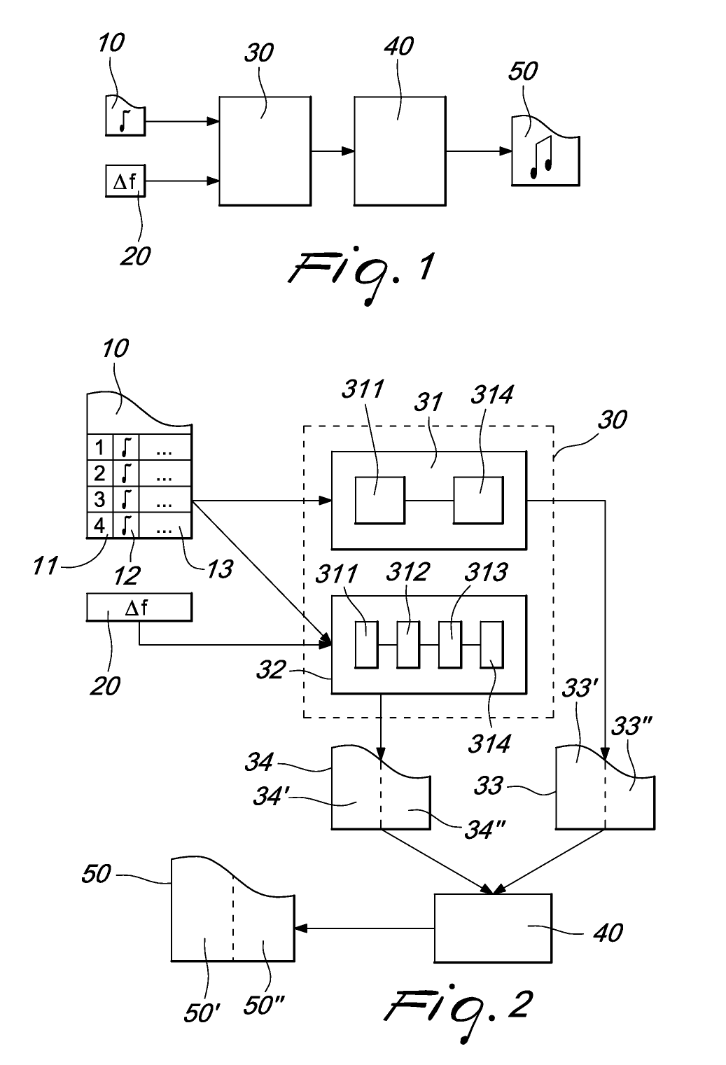

An exemplifying architecture of the system according to the present invention is summarized in the block diagram of FIG. 1.

The diagram shows an input audio signal 10, a parameter 20, a converter module 30, a mixer module 40 and an output audio signal 50.

FIG. 2 is a more detailed view of the architecture described above. In particular, it shows the same audio signal 10, represented by an audio definition file, preferably in the MIDI format.

The audio signal 10 is composed of a sequence of elements, each of which is exemplified as containing an index 11, a note 12 and playback information 13 related to the note.

The parameter 20 represents a frequency which varies in the range related to the alpha, beta, delta and theta waves as described above, i.e., from approximately 0.5 Hz to approximately 30 Hz.

The converter 30 comprises a synthesizer module 31, which in turn comprises a module for reading the following line of audio definition information or fetcher module 311, and a synthesis or conversion module 314. The converter 30 further comprises a shifting module 32, which in turn comprises a fetcher module 311, an approximation module 312, a shifting module 313 and a conversion module 314.

The diagram also includes a first intermediate file, for example encoded within a “way” format 33, a second intermediate file of the “way” type 34, the mixer module 40 and an output audio file 50, also preferably encoded in the “way” format.

The intermediate files 33 and 34 can contain mono signals or multichannel signals, for example stereo tracks 33′, 33″ and 34′, 34″, while the audio recording or file 50 is necessarily of the multichannel type, preferably stereo with two channels 50′ and 50″.

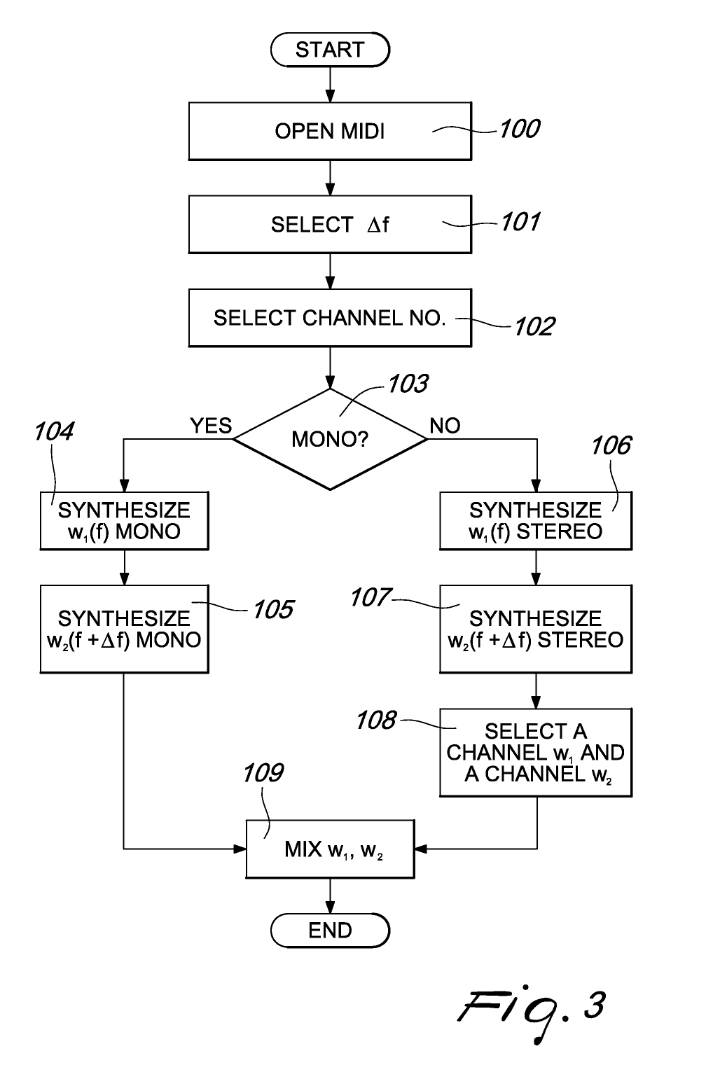

The operation of the system according to the invention is now described with reference to the flowchart of FIG. 3.

In step 100, a sequence of audio definition data 10, for example a digital file in MIDI format, is selected by a user or operator; in step 101, a chosen shift frequency 20 is selected; in step 102, the number of output channels desired for the temporary recordings 33 and 34 is selected.

In particular, in step 104 the system checks whether the temporary recordings 33 and 34 must be of the single-channel or stereo type.

In the case of a single-channel choice, in step 103 the audio definition file 10 is passed in input to the converter 30, particularly to the synthesizer module 31, which starting from the content of said audio definition file 10 generates a corresponding audio recording 33, for example a file in “way” format.

Generation occurs by synthesizing sequentially each note contained in the audio definition sequence 10: in particular, each note is examined by the fetcher module 311 and then synthesized by the conversion module 314.

The conversion module 314 can be any commercially available synthesizing program. For example, in a preferred embodiment the component adopted to implement the conversion module 314 is the open source software synthesizer TiMidity. The result of the conversion is the first single-channel intermediate file 33.

In step 105, the audio definition file 10 and the desired frequency shift value 20 are passed in input to the converter 30, particularly to the module 32, in order to generate the second intermediate recording 34.

The module 32 performs audio generation like the module 31. However, before performing sound synthesis, it applies a frequency shift which is equal to the requested frequency 20 to each note contained in the audio definition file or sequence 10.

In a preferred embodiment, the component adopted to implement the module 32 is the open source software TiMidity, suitably modified so that each individual note contained in the MIDI file, after being examined by the fetcher module 311, is approximated to a pure sound (carrier harmonic), ignoring the frequency content of the other harmonic components that compose the sound, by means of the approximation module 312.

Each note is thus shifted, by using the same frequency value 20, by the shifting module 313. For example, given a frequency value of 5 Hz, a note defined at 100 Hz is brought to 105 Hz and a note defined at 700 Hz is brought to 705 Hz. The shift can of course occur also by subtraction, by subtracting the frequency value 20 rather than adding it. The result of the shift is the second recording or second intermediate file 34.

At this point, therefore, two intermediate audio recordings 33 and 34 have been generated, and the first one has a content which corresponds to the definition contained in the audio definition sequence 10, while the second one has a content which corresponds to the definition contained in the same audio definition 10 but in which each note has been shifted in terms of frequency by a value equal to the frequency parameter 20.

The system has a similar operating mode if an intermediate generation of stereo files is chosen: in step 106, the audio definition file 10 is input to the converter 30 and the result of the conversion is the first intermediate file 33, a file of the stereo type with two channels 33′ and 33″.

In step 107, the audio definition file 10 and the frequency value 20 are passed in input to the converter 30. The result of the conversion is the second intermediate file 34, a file of the stereo type with two channels 34′ and 34″. In step 108, the system selects a channel of the stereo file 33 and a channel of the stereo file 34.

Clearly, the order of generation of the intermediate files 33 and 34 is irrelevant: it can be any, or the files can be generated in parallel in the case of a multiprocessor system.

Finally, both if the single-channel option has been selected and if the stereo or multichannel generation mode has been selected, in step 109 the two intermediate files thus generated are sent in input to the mixer module 40, i.e., to a mixer which mixes the two intermediate files so that each one constitutes a channel of a single stereo file 50: the file 50 is therefore an audio file of the stereo type with two channels 50′ and 50″.

In particular, in the case of intermediate recordings of the stereo type, the mixer module 40 can select a channel starting from each intermediate audio recording 33, 34, for example, the channels 33′ and 34′, in order to generate the final audio recording 50, which comprises the channels 50′ and 50″.

The mixer module 40 can be provided by means of conventional software. For example, in a preferred embodiment the component adopted to implement the module 40 can be the Goldwave application.

The final product of the processing described above is therefore the audio recording 50, a stereo file in which, for each note, between the right channel and the left channel there is a frequency shift Δf equal to the selected value 20.

The audio file 50 thus generated optimizes the biauricular content, since the entire piece of music, or entire portions thereof, is constituted by notes which are mutually differentiated by a predefined frequency. Therefore, the biauricular piece of music is no longer a conventional piece of music accompanied by biauricular percussions or backing tracks, but a piece of music in which the entire melody thus generated seeks the desired effect.

The system and the method described above are applied in several contexts.

In a first aspect, the system can be implemented and made available in the form of an Internet service. A user, by connecting to an Internet site managed by a service provider, can select a MIDI track within a plurality of predefined tracks or load a track of his own which is available on his computer, select the type of desired effect or directly the desired shift frequency 20, and obtain in return a complete biauricular audio file 50, in any format which can be played back by a personal computer or conventional playback devices, for example by mp3 players.

In a second aspect, audio generated by a system or by a method according to the invention can be used advantageously in different entertainment systems. In particular, biauricular pieces of music according to the invention can be used within videogames in order to obtain relaxation effects on the videogame player, thus combining the gaming pleasure produced by the videogame with a synergistic relaxation effect induced by the audio of the videogame itself.

In the same manner, audio generated by a system or method according to the invention can be used advantageously in documentaries, motion pictures, short films, feature films and videos in general, all of which are identified here by the expression “audiovisual document”.

It has thus been shown that the described method and system achieve the intended aim and objects. In particular, it has been shown that the method thus conceived allows to overcome the quality limitations of the background art due to the fact that after a suitable selection of the input track and of the desired shift frequency, it allows the conversion of any piece of music defined by means of any digital music protocol, for example MIDI, controlling the type of effect to be inserted. The resulting track is therefore not a conventional track accompanied by biauricular rhythms but a biauricular track as such.

Thanks to this invention, moreover, it is no longer necessary to listen to previously prepared tracks in order to achieve a beneficial brain effect, but tracks which one already owns can be enriched with these effects; for example, a same track which is particularly appreciated can be processed multiple times with different shifts or different frequency shifts in order to obtain a relaxation effect one time and a concentration increase effect another time.

In other words, the biauricular theory becomes, with this invention, a product which can be modulated and with which one's everyday sound enjoyment experience can be enriched at will.

Of course, numerous modifications will be apparent and can be promptly performed by the person skilled in the art without abandoning the scope of the appended claims. For example, it is obvious for the person skilled in the art to store the intermediate audio recordings and the audio recording in output from the system in any other format which is different from the ones mentioned above.

Moreover, it is clear that the system can be provided also by integrating the frequency shift within a MIDI instrument: in this manner, the user of the instrument would produce directly, in real time, sounds and melodies with a biauricular effect.

The scope of the claims must not be limited by the illustrations or by the preferred embodiments illustrated in the description by way of examples, but rather the claims must comprise all the characteristics of patentable novelty that reside within the present invention, including all the characteristics that would be treated as equivalents by the person skilled in the art.

1-18. (canceled)

19. A method for processing an audio signal, comprising the steps of:
a) acquiring a set of data suitable to define an audio signal composed of a sequence of elements, each element comprising a note and playback information related to the note;
b) selecting a frequency shift;
c) generating a first digital audio recording by synthesizing it according to said data set;
d) generating a second digital audio recording by synthesizing each note contained in said data set on the basis of said note, of said playback information and of said frequency shift;
e) selecting a channel of said first audio recording, selecting a channel of said second audio recording, and mixing the two channels in a third audio recording which comprises at least two channels.

20. The method according to claim 19, wherein at least one between said step of generating a first audio recording and said step of generating a second audio recording comprises generating a single-channel audio recording.

21. The method according to claim 19, wherein at least one between said step of generating a first audio recording and said step of generating a second audio recording comprises generating a multichannel, preferably two-channel, audio recording.

22. The method according to claim 19, wherein said step of generating a second audio recording comprises the application of said frequency shift to each note of said set of data suitable to define an audio signal.

23. The method according to claim 19, wherein said data suitable to define an audio signal are a file in the MIDI format.

24. The method according to claim 19, wherein said frequency shift falls in the range from 0.5 Hz to 30 Hz, preferably in the range from 2 Hz to 20 Hz.

25. The method according to claim 19, wherein said first, second and third audio recordings are in a format selected from the group that comprises “way”, “mp3”, “ogg”, “xac”, “aiff”, “aifc”, “iff”, “au”, “voc”, “snd”, “sds”, “smp”, “vox”, “mat”, “txt”, “flac”, “ogg”, “wma”.

26. A system for processing an audio signal, comprising:
a) means for acquiring a set of data suitable to define an audio signal composed of a sequence of elements, each element comprising a note and playback information related to the note;
b) means for selecting a frequency shift;
c) a first synthesizer which is adapted to generate a first digital audio recording on the basis of said data adapted to define an audio signal;
d) a second synthesizer which is adapted to generate a second digital audio recording by synthesizing each note contained in said data set on the basis of said note, of said playback information and of said frequency shift;
e) a mixer which is adapted to select a channel of said first audio recording, select a channel of said second audio recording, and mix the two channels in a third audio recording which comprises at least two channels.

27. The system according to claim 26, wherein at least one between said first synthesizer and said second synthesizer generates a single-channel audio recording.

28. The system according to claim 26, wherein at least one between said first synthesizer and said second synthesizer generates a multichannel, preferably two-channel, audio recording.

29. The system according to claim 26, wherein said second synthesizer comprises means for applying said frequency shift to each note of the audio signal.

30. The system according to claim 26, wherein said data adapted to define an audio signal are a file in the MIDI format.

31. The system according to claim 26, wherein said frequency shift falls within the range from 0.5 Hz to 30 Hz, preferably in the range from 2 Hz to 20 Hz.

32. The system according to claim 26, wherein said first, second and third audio recordings are in a format selected from the group that comprises “way”, “mp3”, “ogg”, “xac”, “aiff”, “aifc”, “iff”, “au”, “voc”, “snd”, “sds”, “smp”, “vox”, “mat”, “txt”, “flac”, “ogg”, “wma”.

33. A multichannel, preferably two-channel, audio recording, comprising an audio track composed of a sequence of musical notes, wherein each note in said sequence is coded in a first channel at a frequency f and each note in said sequence is coded in a second channel at a frequency f+Δf.

34. An audio recording which can be obtained by means of claim 33.

35. A videogame comprising digital audio according to claim 33.

36. An audiovisual document comprising digital audio according to claim 33.
